(19) United States
(12) Patent Application Publication
(10) Pub. No.: US 2010/0221560 A1
(43) Pub. Date: Sep. 2, 2010

(54) Bio-Based In-Line High Barrier Metalized Film and Process for its Production

(75) Inventors: Anthony Robert Knoerzer, Parker, TX (US); Kenneth Scott Laverdure, Plano, TX (US); Eldridge M. Mount, III, Canandaigua, NY (US); Brad Dewayne Rodgers, Frisco, TX (US)

Correspondence Address: CARSTENS & CAHOON, LLP, P O BOX 802334, DALLAS, TX, 75380, US

(73) Assignee: FRITO-LAY NORTH AMERICA, INC., Plano, TX (US)

(21) Appl. No.: 12/716,033

(22) Filed: Mar. 2, 2010

Related U.S. Application Data
(63) Continuation-in-part of application No. 12/031,500, filed on Feb. 14, 2008.
Application No. 12/031,500 is a continuation-in-part of application No. 11/464,331, filed on Aug. 14, 2006.
Application No. 11/464,331 is a continuation-in-part of application No. 11/848,775, filed on Aug. 31, 2007.

(51) Int. Cl. B32B 15/08; B32B 37/02; B29C 47/00; B32B 27/06; B32B 15/09

(52) U.S. Cl. 428/458; 156/60; 156/244.11; 428/457; 428/702; 428/480; 428/461; 428/500

(57) ABSTRACT

Bio-based high barrier metalized film such as PLA or PHA has an adhesion layer coated or co-extruded with the bio-based film and a metal oxide is disposed on the adhesion layer. The adhesion layer can be a co-extruded polyethylene terephthalate, nylon, polyglycolic acid, or ethylene vinyl alcohol. The adhesion layer can have a coating of EVOH, a nylon/EVOH blend, PVOH, PVOH/EAA mixtures, or a primer.

### CROSS REFERENCE TO RELATED APPLICATION

This application is a continuation-in-part of co-pending U.S. patent application Ser. No. 12/031,500, filed Feb. 14, 2008, which is a continuation-in-part of co-pending U.S. patent application Ser. No. 11/464,331, filed Aug. 14, 2006, and a continuation-in-part of co-pending U.S. patent application Ser. No. 11/848,775, filed Aug. 31, 2007, the technical disclosures of which are hereby incorporated by reference in their entirety.

### BACKGROUND OF THE INVENTION

1. Technical Field

The present invention relates to a bio-based flexible packaging material having acceptable barrier properties for packaging food products and to a method of making such material.

2. Description of Related Art

Multi-layered film structures made from petroleum-based products originating from fossil fuels are often used in flexible packages where there is a need for its advantageous barrier, sealant, and graphics-capability properties. Barrier properties in one or more layers are important in order to protect the product inside the package from light, oxygen or moisture. Such a need exists, for example, for the protection of foodstuffs, which may run the risk of flavor loss, staling, or spoilage if insufficient barrier properties are present to prevent transmission of such things as light, oxygen, or moisture into the package. The sealant properties are important in order to enable the flexible package to form an airtight or hermetic seal. Without a hermetic seal, any barrier properties provided by the film are ineffective against oxygen, moisture, or aroma transmission between the product in the package and the outside. A graphics capability is needed because it enables a consumer to quickly identify the product that he or she is seeking to purchase, allows food product manufacturers a way to label the nutritional content of the packaged food, and enables pricing information, such as bar codes to be placed on the product.

One prior art multi-layer or composite film used for packaging potato chips and like products is illustrated in FIG. 1 which is a schematic of a cross section of the multi-layer film 100 illustrating each individual substantive layer. Each of these layers functions in some way to provide the needed barrier, sealant, and graphics capability properties. For example, the graphics layer 114 is typically used for the presentation of graphics that can be reverse-printed and viewed through a transparent outer base layer 112. Like numerals are used throughout this description to describe similar or identical parts, unless otherwise indicated. The outer base layer 112 is typically oriented polypropylene (“OPP”) or polyethylene terephthalate (“PET”). A metal layer disposed upon an inner base layer 118 provides the required barrier properties. It has been found and is well known in the prior art that metalizing a petroleum-based polyolefin such as OPP or PET reduces the moisture and oxygen transmission through the film by approximately three orders of magnitude. Petroleum-based OPP is typically utilized for base layers 112, 118 because of its lower cost. A sealant layer 119 disposed upon the OPP layer 118 enables a hermetic seal to be formed at a temperature lower than the melt temperature of the OPP. A lower melting point sealant layer 119 is desirable because melting the metalized OPP to form a seal could have an adverse effect on the barrier properties. Typical prior art sealant layers 119 include an ethylene-propylene co-polymer and an ethylene-propylene-butene-1 ter-polymer. A glue layer 115, typically a polyethylene extrusion, is required to adhere the outer base layer 112 with the inner, product-side base layer 118. Thus, at least two base layers of petroleum-based polypropylene are typically required in a composite or multi-layered film.

Other materials used in packaging are typically petroleum-based materials such as polyester, polyolefin extrusions, adhesive laminates, and other such materials, or a layered combination of the above.

FIG. 2 demonstrates schematically the formation of material, in which the OPP layers 112, 118 of the packaging material are separately manufactured, then formed into the final material 100 on an extrusion laminator 200. The OPP layer 112 having graphics 114 previously applied by a known graphics application method such as flexographic or rotogravure is fed from roll 212 while OPP layer 118 is fed from roll 218. At the same time, resin for polyethylene (“PE”) laminate layer 115 is fed into hopper 215a and through extruder 215b, where it will be heated to approximately 600° F. and extruded at die 215c as molten polyethylene 115. This molten polyethylene 115 is extruded at a rate that is congruent with the rate at which the petroleum-based OPP materials 112, 118 are fed, becoming sandwiched between these two materials. The layered material 100 then runs between chill drum 220 and nip roller 230, ensuring that it forms an even layer as it is cooled. The pressure between the laminator rollers is generally set in the range of 0.5 to 5 pounds per linear inch across the width of the material. The large chill drum 220 is made of stainless steel and is cooled to about 50-60° F., so that while the material is cooled quickly, no condensation is allowed to form. The smaller nip roller 230 is generally formed of rubber or another resilient material. Note that the layered material 100 remains in contact with the chill drum 220 for a period of time after it has passed through the rollers, to allow time for the resin to cool sufficiently. The material can then be wound into rolls (not specifically shown) for transport to the location where it will be used in packaging. Generally, it is economical to form the material as wide sheets that are then slit using thin slitter knives into the desired width as the material is rolled for shipping.

Once the material is formed and cut into desired widths, it can be loaded into a vertical form, fill, and seal machine to be used in packaging the many products that are packaged using this method. FIG. 3 shows an exemplary vertical form, fill, and seal machine that can be used to package snack foods, such as chips. This drawing is simplified, and does not show the cabinet and support structures that typically surround such a machine, but it demonstrates the working of the machine well. Packaging film 310 is taken from a roll 312 of film and passed through tensioners 314 that keep it taut. The film then passes over a former 316, which directs the film as it forms a vertical tube around a product delivery cylinder 318. This product delivery cylinder 318 normally has either a round or a somewhat oval cross-section. As the tube of packaging material is pulled downward by drive belts 320, the edges of the film are sealed along its length by a vertical sealer 322, forming a back seal 324. The machine then applies a pair of heat-sealing jaws 326 against the tube to form a transverse seal 328. This transverse seal 328 acts as the top seal on the bag 330 below the sealing jaws 326 and the bottom seal on the bag 332 being filled and formed above the jaws 326. After the transverse seal 328 has been formed, a cut is made across the sealed area to separate the finished bag 330 below the seal 328 from the partially completed bag 332 above the seal. The film tube is then pushed downward to draw out another package length. Before the sealing jaws form each transverse seal, the product to be packaged is dropped through the product delivery cylinder 318 and is held within the tube above the transverse seal 328.

A disadvantage of petroleum-based films is that they are made from oil, which many consider to be a limited, non-renewable resource. Consequently, a need exists for a bio-based flexible film made from a renewable resource. One problem with bio-based polymer films is that such films are notorious for having poor barrier properties. Further, many bio-based films do not metalize as well as OPP as evidenced by the fact that metalized PLA does not have barrier properties much different from unmetalized PLA. Consequently, a need exists for a bio-based composite with barrier properties. Such bio-based composite can be used to make a multi-layer flexible film. Such multi-layer flexible film should be food safe and have the requisite barrier properties to store a low moisture shelf-stable food for an extended period of time without the product staling. The film should have the requisite sealable and coefficient of friction properties that enable it to be used on existing vertical form, fill, and seal machines.

### SUMMARY OF THE INVENTION

One embodiment of the present invention is directed towards a bio-based composite and method for making a bio-based composite comprising a bio-based film layer such as a PLA or PHA film layer and an adhesion layer having a metal, a metal oxide, and/or a metalloid oxide, deposited thereon. The adhesion layer can be co-extruded with or coated onto the bio-based film layer. The adhesion layer can be selected from a suitable polar polymer such as amorphous PET, nylon, EVOH, PVOH, PVOH/EAA blends, PGA, a primer, and combinations thereof. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a cross-section of an exemplary prior art packaging film;

FIG. 2 depicts the exemplary formation of a prior art packaging film;

FIG. 3 depicts a vertical form, fill, and seal machine that is known in the prior art; and

FIG. 4 depicts a magnified schematic cross-section of a multi-layer packaging film made according to one embodiment of the invention.

### DETAILED DESCRIPTION

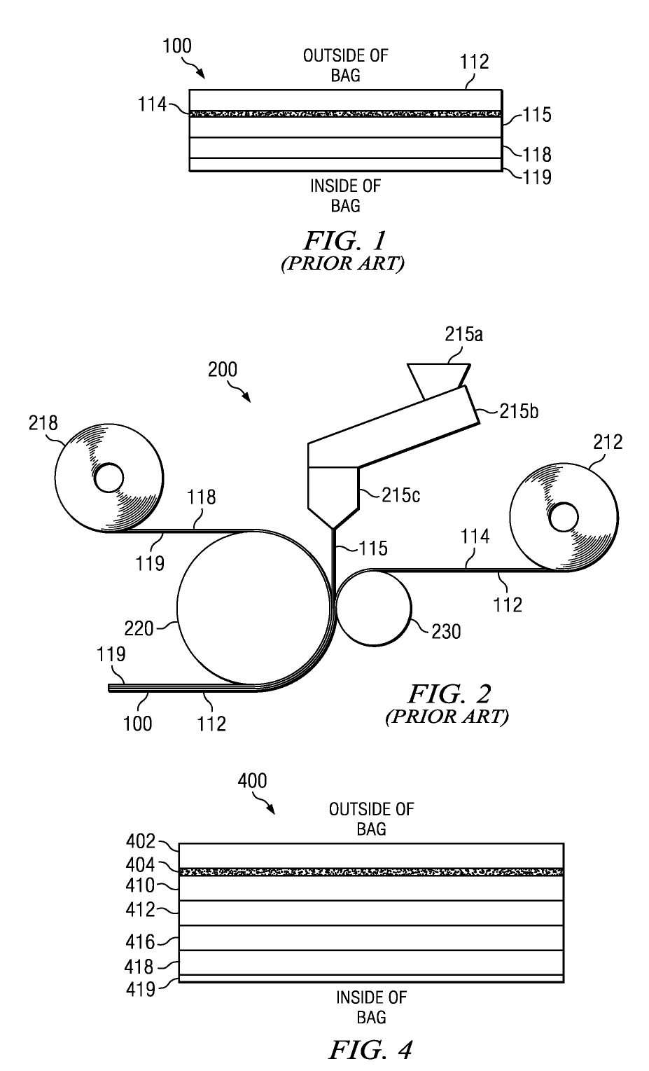

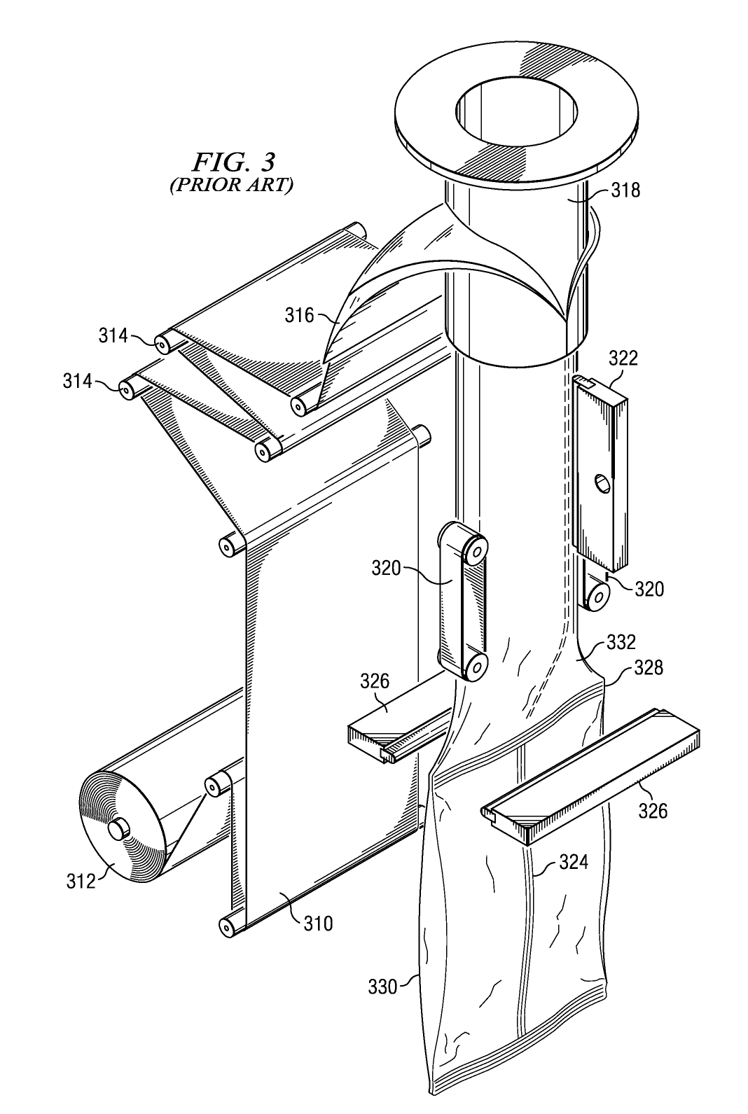

FIG. 4 depicts a magnified schematic cross-section of a multi-layer packaging film 400 made according to one embodiment of the invention. Referring to FIG. 4, the multi-layer packaging film 400 comprises a barrier layer 412 adhered by an adhesion layer 416 to a bio-based layer 418. These three layers can be used as a film composite for making a multilayer packaging film 400 that has both acceptable barrier properties and a bio-based film.

As used herein, a barrier layer 412 comprises a metal, metal oxide, metalloid oxide, and combinations thereof. Barrier layers 412 described herein can be applied to the adhesion layer 416 by any suitable method known in the art, including, but not limited to evaporation, sputtering, chemical vapor deposition, combustion chemical vapor deposition, physical vapor deposition, plasma deposition, plasma enhanced chemical vapor deposition, vacuum deposition, flame deposition, and flame hydrolysis deposition. As used herein, a multilayer packaging film 400 that has acceptable barrier properties has both acceptable oxygen barrier properties and moisture barrier properties. As used herein, a multi-layer packaging film 400 having acceptable oxygen barrier properties has an oxygen transmission rate of less than about 150 cc/m²/day (ASTM D-3985). As used herein, a multi-layer packaging film 400 having acceptable moisture barrier properties comprises a water vapor transmission rate of less than about 5 grams/m²/day (ASTM F-1249).

As used herein, the term “bio-based film” means a polymer film where at least 80% of the polymer film by weight is derived from a non-petroleum feedstock. In one embodiment, up to about 20% of the bio-based film can comprise a conventional polymer sourced from petroleum. Examples of bio-based films include polylactide also known as polylactic acid (“PLA”) and polyhydroxy-alkanoate (“PHA”).

PLA can be made from plant-based feedstocks including soybeans, as illustrated by U.S. Patent Application Publication Number 2004/0229327 or from the fermentation of agricultural by-products such as corn starch or other plant-based feedstocks such as corn, wheat, or sugar beets. PLA can be processed like most thermoplastic polymers into a film. PLA has physical properties similar to PET and has excellent clarity. PLA films are described in U.S. Pat. No. 6,207,792 and PLA resins are available from Natureworks LLC (http://www.natureworksllc.com) of Minnetonka, Minn. PLA degrades into carbon dioxide and biomass. PLA films used in accordance with the present invention are substantially insoluble in water under ambient conditions.

PHA is available from Archer Daniels Midland of Decatur, Ill. PHA is a polymer belonging to the polyesters class and can be produced by microorganisms (e.g. Alcaligenes eutrophus) as a form of energy storage. In one embodiment, microbial biosynthesis of PHA starts with the condensation of two molecules of acetyl-CoA to give acetoacetyl-CoA which is subsequently reduced to hydroxybutyryl-CoA. Hydroxybutyryl-CoA is then used as a monomer to polymerize PHB, the most common type of PHA.

In one embodiment, any polymer or polymer blend that processes similar to the bio-based film on an orientation line, that has a relatively smooth surface (such as provided by an amorphous PET v. a crystalline PET, described in more detail below) and that has polar chemical groups, can be used as a suitable adhesion layer 416. Polar chemical groups are desirable in the adhesion layer 416 because they are attracted to the metal or metalloid barrier layer 412, and it is believed that polar chemical groups such as hydroxyl groups covalently bond to form a metal oxide or metalloid oxide upon metalization. Consequently, alcohol blends using an ethylene vinyl alcohol (“EVOH”) formula and polyvinyl alcohol (“PVOH”) are desirable, as are polymers having polar amide groups such as nylon. Further, amorphous PET and polyglycolic acid (“PGA”) having polar carbonyl groups can also be used. Consequently, in one embodiment, an adhesion layer 416 comprises one or more polar films selected from amorphous PET, PGA, various nylons including amorphous nylon, EVOH, nylon/EVOH blends, PVOH, PVOH/ethylene acrylic acid (hereinafter “EAA”) blends, and a primer.

In one embodiment, an adhesion layer 416 comprises an amorphous or glassy PET. As used herein, the terms amorphous PET and glassy PET are synonymous and defined as a PET having Tg of about 80° C. In one embodiment, amorphous PET is PET that is less than about 75% crystalline in nature. The determination of crystallinity is well known in the art and can be performed with differential scanning calorimetry (DSC) in accordance with ASTM D3418 (melting points) or ASTM E1356 (Tg). Because amorphous PET has a much smoother outer bonding surface than crystalline PET, and because the oxygen bearing groups are randomly distributed at the surface, amorphous PET provides a much better bonding surface than crystalline PET for metals such as aluminum. Further, crystalline PET has a much higher melting point and does not process in an efficient manner with PLA on an orientation line.

In one embodiment, the adhesion layer 416 is co-extruded with a bio-based layer 418. In one embodiment, an adhesion layer 416 comprising PET can be coextruded with the bio-based layer 418 and a barrier layer 412 can be applied to the adhesion layer 416 by methods known in the art.

In one embodiment, the adhesion layer 416 comprises an EVOH formula that can range from a low hydrolysis EVOH to a high hydrolysis EVOH. Below depicts EVOH formulas in accordance with various embodiments of the present invention.

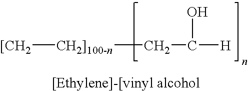

As used herein a low hydrolysis EVOH corresponds to the above formula wherein n=25. As used herein, a high hydrolysis EVOH corresponds to the above formula wherein n=80. High hydrolysis EVOH provides oxygen barrier properties but is more difficult to process. The adhesion layer 416 comprising the EVOH formula can be coextruded with the bio-based layer 418 and the barrier layer 412 can be applied by methods known in the art and listed above. In one embodiment, the adhesion layer 416 comprising EVOH is coated via a gravure or other suitable method onto the bio-based layer 418 and the barrier layer 412 can be applied onto the adhesion layer 416.

In one embodiment, the adhesion layer 416 comprises both nylon and EVOH. In such embodiment, a nylon layer is co-extruded with a bio-based layer 418 such as PLA and then an EVOH coating is applied onto the nylon layer, via gravure or other suitable method.

In one embodiment, the adhesion layer 416 comprises a PVOH coating that is applied to the bio-based layer 418 as a liquid and then dried. A barrier layer 412 can then be applied to the adhesion layer 416 comprising the dried PVOH coating.

In one embodiment, the adhesion layer 416 is applied as a solution comprising EAA and PVOH that is coated onto the bio-based layer 418 as a liquid and then dried. In one embodiment, a PVOH and EAA solution coating can be applied to the PLA after the PLA has been stretched or axially oriented in the machine direction. Consequently, PLA can be extruded and allowed to cool after extrusion prior to being stretched in the machine direction. A coating comprising PVOH and EAA can then be applied. For example, the solution can comprise 0.1-20% PVOH and EAA and 80-99.9% water. In one embodiment, roughly equal amounts of PVOH and EAA are used. In one embodiment, the solution comprises about 90% water, about 5% PVOH, and about 5% EAA. After the coating has been applied, the film can then be heated and subsequently stretched in the transverse direction. Such process provides an even coating for a barrier layer 412.

FIG. 4 depicts a magnified schematic cross-section of a multi-layer packaging film made according to one embodiment of the invention. In one embodiment, a bio-based layer 418 is coated, by any suitable method including use of a mayer rod or gravure, with an adhesion layer 416 comprising a primer. As used herein, a primer is defined as any suitable coating that has polar chemical groups and also functions as a surface modifier that provides a smooth surface for a barrier layer 412. Examples of suitable primers that can be used in accordance with various embodiments of the present invention include, but are not limited to, an epoxy, maleic anhydride, ethylenemethacrylate (“EMA”), and ethylenevinylacetate (“EVA”). Other suitable primers include OXY-BLOCK coatings available from Akzo Nobel packaging coatings and OPADRY available from Colorcon of Harleysville, Pa. In one embodiment, the adhesion layer 416 is coated with a barrier layer 412. Any suitable barrier layer 412 including, but not limited to, a metal oxide such as aluminum oxide, or a metalloid oxide such as silicon dioxide can be used. In one embodiment, another layer (not shown) comprising doped metal oxide or metalloid oxide is placed is placed onto the barrier layer 412 to provide additional barrier properties. For example, in one embodiment, the adhesion layer 416 comprises an OXY-BLOCK epoxy on the bio-based layer 418 to provide a smooth surface for subsequent depositions. In one embodiment a barrier layer 412 comprising silicon oxide is then coated, via flame deposition in one embodiment, onto the epoxy layer and provides an oxygen barrier. A doped zinc-silicon oxide can then be coated, via flame deposition in one embodiment, onto the barrier layer 412 comprising silicon oxide.

Additives can also be used to facilitate the application of the barrier layer 412 such as a metal to the adhesion layer 416 or to facilitate application of the adhesion layer 416 to a bio-based layer 418. As used herein, the term “additives” is not limited to chemical additives and can include surface treatment including, but not limited to, corona treatment. In one embodiment, use of the adhesion layer 416 makes it possible to provide a barrier layer 412 with no additives.

The film composite comprising a barrier layer 412 and adhesion layer 416 and a bio-based layer 418 described above can then be adhered to a bio-based outer layer 402 with a bio-based or other suitable adhesive 410.

An outer bio-based outer layer 402 can be made by extruding a bio-based polymer into a film sheet. In one embodiment, the bio-based outer layer 402 has been oriented in the machine direction or the transverse direction. In one embodiment, the bio-based outer layer 402 comprises a biaxially oriented film. Such biaxially oriented film is available as a PLA film from SKC Ltd. of South Korea. In one embodiment, PLA outer layer 402 used comprises a thickness of between about 70 gauge and about 120 gauge. In one embodiment, a graphic image 404 is reverse printed onto the bio-based outer layer 402 by a known graphics application method such as flexographic or rotogravure to form a graphics layer 404. In an alternative embodiment (not shown), a graphic image is printed onto the outside facing portion of the outer layer 402. In one embodiment, the bio-based outer layer 402 comprises multiple layers to enhance printing and coefficient of friction properties. In one embodiment, the bio-based outer layer 402 comprises one or more layers consisting essentially of PLA.

In one embodiment, after a barrier layer 412 has been applied to the adhesion layer 416, the bio-based print web 402 can be adhered to the barrier layer 412 with any suitable adhesive 410 such as LDPE. In one embodiment, a bio-based adhesive 410 is used. As used herein, the term “bio-based adhesive” means a polymer adhesive where at least about 80% of the polymer layer by weight is derived from a non-petroleum feedstock. The adhesive layer 410 can comprise any suitable bio-based adhesive such as a modified PLA biopolymer 26806 available from DaniMer Scientific LLC of Bainbridge, Ga. or Mater Bi available from Novamont of Novara, Italy. In one embodiment, a starch based glue can be used as a suitable adhesive 410.

An optional sealant layer 419 can also be provided. In one embodiment, the sealant layer 419 comprises an amorphous PLA, such as a 4060 PLA layer available from NATUREWORKS that is co-extruded with the bio-based layer 418. In the embodiment shown in FIG. 4, the inside sealant layer 419 can be folded over and then sealed on itself to form a tube having a fin seal for a back seal. The fin seal is accomplished by the application of heat and pressure to the film. Alternatively, a thermal stripe can be provided on the requisite portion of the bio-based film 402 to permit a lap seal to be used.

In one embodiment, depicted in FIG. 4, the present invention provides a bio-based multi-layer film comprising three bio-based film layers (402, 410, 418) wherein the multi-layer film has over 90% less polyolefins than the prior art film depicted in FIG. 1 yet comprises acceptable oxygen and moisture barrier properties.

Water vapor transmission rates of crystalline PLA film (NATUREWORKS 4032D) corresponding to bio-based layer 418 in FIG. 4 coextruded with various adhesion layers (e.g., adhesion layer 416 depicted in FIG. 4) and a barrier layer 412 were recorded under various conditions and are depicted in Table 1 below. Testing was conducted without the print layer 402 or ink 404 layer. The relative humidity of the testing conditions, temperature at which the test was conducted and the flow rate in standard cubic centimeters per minute are recorded in the table below. All PLA bio-based layers 418 are 80 gauge crystalline PLA. As used herein, a PLA having greater than about 50% crystallinity is considered crystalline PLA, while PLA having less than about 50% crystallinity is amorphous PLA. Applicants note that petroleum-based polyolefins such as PET are considered amorphous below about 75% and crystalline above about 75%. Skin layers are made from various PLA polymers. For example 4042D is a crystalline PLA and 4060D is an amorphous PLA polymer available from NATUREWORKS LLC.

Samples 1-8 demonstrate the water vapor transmission rate of an aluminum oxide (412) coated crystalline PLA layer (416) co-extruded with a PLA layer (418).

Samples 9-16 demonstrate the water vapor transmission rate of an aluminum oxide (412) coated amorphous PLA layer (416) co-extruded with a PLA layer (418).

Samples 17-24 demonstrate the water vapor transmission rate of an aluminum oxide (412) coated nylon layer (416) co-extruded with a PLA layer (418).

Samples 25-32 demonstrate the water vapor transmission rate of an aluminum oxide (412) coated amorphous PET (416) layer co-extruded with a PLA layer (418).

TABLE 1
Water Vapor Transmission Rate Measurements of various metalized
skin layers/PLA co-extrusions.

| | | | | | | Flow Rate, |
|---|---|---|---|---|---|---|
| | | Aluminum oxide | | | | Standard |
| | | coated (412) | | | | Cubic |
| | WVTR, | Adhesion layer | Bio-based | Temp | Relative | Centimeters |
| Sample | g/m²/day | (416) | layer (418) | ° C. | Humidity, % | per minute |

Crystalline PLA (4042D) skin layer

| | | | | | | |
|---|---|---|---|---|---|---|
| 1 | 1.326931 | 4042D | PLA | 23 | 49.1701 | 9.82 |
| 2 | 1.081702 | 4042D | PLA | 23 | 49.0334 | 10.52 |
| 3 | 2.081119 | 4042D | PLA | 23 | 51.6823 | 11.56 |
| 4 | 2.442083 | 4042D | PLA | 23 | 49.9204 | 10.05 |
| 5 | 6.036424 | 4042D | PLA | 30 | 77.3633 | 11.64 |
| 6 | 3.141985 | 4042D | PLA | 30 | 79.2038 | 10.22 |
| 7 | 4.146621 | 4042D | PLA | 30 | 78.8987 | 9.9 |
| 8 | 4.085273 | 4042D | PLA | 30 | 77.8049 | 10.52 |

Amorphous PLA (4060D) skin layer

| | | | | | | |
|---|---|---|---|---|---|---|
| 9 | 5.295441 | 4060D | PLA | 30 | 82.8041 | 12.48 |
| 10 | 4.594714 | 4060D | PLA | 30 | 83.9561 | 11.86 |
| 11 | 8.938544 | 4060D | PLA | 30 | 78.9874 | 11.45 |
| 12 | 4.892574 | 4060D | PLA | 30 | 73.5009 | 10.47 |
| 13 | 0.906453 | 4060D | PLA | 23 | 54.908 | 12.45 |
| 14 | 1.386098 | 4060D | PLA | 23 | 54.732 | 11.2 |
| 15 | 1.478168 | 4060D | PLA | 23 | 47.7843 | 9.89 |
| 16 | 2.331799 | 4060D | PLA | 23 | 47.8465 | 10.58 |

Nylon skin layer

| | | | | | | |
|---|---|---|---|---|---|---|
| 17 | 4.609288 | Nylon | PLA | 30 | 78.5517 | 10.64 |
| 18 | 2.086448 | Nylon | PLA | 30 | 81.4597 | 12.31 |
| 19 | 2.446534 | Nylon | PLA | 30 | 81.6593 | 12.37 |
| 20 | 2.406108 | Nylon | PLA | 30 | 82.456 | 11.85 |
| 21 | 0.530395 | Nylon | PLA | 23 | 51.7281 | 11.39 |
| 22 | 0.537551 | Nylon | PLA | 23 | 49.9603 | 10.8 |
| 23 | 0.625595 | Nylon | PLA | 23 | 51.4452 | 11.49 |
| 24 | 0.769674 | Nylon | PLA | 23 | 50.5645 | 10 |

Amorphous PET skin layer

| | | | | | | |
|---|---|---|---|---|---|---|
| 25 | 0.573104 | PET-G | PLA | 30 | 79.3097 | 11.37 |
| 26 | 0.681473 | PET-G | PLA | 30 | 74.7511 | 10.55 |
| 27 | 1.350984 | PET-G | PLA | 30 | 80.1199 | 9.85 |
| 28 | 0.872355 | PET-G | PLA | 30 | 81.1413 | 10.36 |
| 29 | 0.293232 | PET-G | PLA | 23 | 51.3811 | 10.58 |
| 30 | 0.038133 | PET-G | PLA | 23 | 50.18 | 12.3 |
| 31 | 0.306664 | PET-G | PLA | 23 | 54.471 | 12.35 |
| 32 | 0.424133 | PET-G | PLA | 23 | 54.6062 | 11.14 |

The data above illustrates the comparative effectiveness of glossy or amorphous polyethylene terephthalate as an adhesion layer 416. When PET is used as a co-extruded adhesion layer 416, the water vapor transmission rate is more effective by nearly an order of magnitude over both crystalline PLA (4042D) and amorphous PLA (4060D), as illustrated by comparing samples 25-32 with samples 1-8 and 9-16, respectively.

Similarly, use of nylon as a co-extruded adhesion layer 416 on a PLA layer 418 appears to have substantially better barrier characteristics than an amorphous PLA adhesion layer 416. The present invention advantageously reduces consumption of fossil fuels where the bio-based layer 418 is being used as a packaging film yet maintains acceptable moisture and oxygen barrier properties.

As used herein, the term “package” should be understood to include any container including, but not limited to, any food container made up of multi-layer thin films. The sealant layers, adhesive layers, outer layers for print, and bio-based layers as discussed herein are particularly suitable for forming packages for snack foods such as potato chips, corn chips, tortilla chips and the like. However, while the layers and films discussed herein are contemplated for use in processes for the packaging of snack foods, such as the filling and sealing of bags of snack foods, the layers and films can also be put to use in processes for the packaging of other low moisture products.

Unless otherwise defined, all technical and scientific terms used herein have the same meaning as commonly understood by one of ordinary skill in the art to which this invention belongs. All references cited herein are incorporated by reference; however, in case such references conflict with the present disclosure, including references within the priority documents, the present disclosure controls. While this invention has been particularly shown and described with reference to a preferred embodiment, it will be understood by those skilled in the art that various changes in form and detail may be made therein without departing from the spirit and scope of the invention.

What is claimed is:

1. A composite for use on a product side of a multi-layer packaging film, said composite comprising a bio-based layer selected from PLA, PHA, and mixtures thereof and an adhesion layer having a metal, metal oxide, metalloid oxide, or combinations thereof deposited thereon.

2. The composite of claim 1 wherein said adhesion layer and said bio-based layer is co-extruded.

3. The composite of claim 2 wherein said bio-based film layer comprises a sealant layer comprising amorphous PLA.

4. The composite of claim 2 wherein said adhesion layer comprises amorphous PET.

5. The composite of claim 2 wherein said adhesion layer comprises PGA.

6. The composite of claim 2 wherein said adhesion layer comprises EVOH.

7. The composite of claim 2 wherein said adhesion layer comprises nylon.

8. The composite of claim 7 wherein said adhesion layer further comprises an EVOH coating.

9. The composite of claim 1 further comprising a bio-based adhesive.

10. The composite of claim 1 wherein said adhesion layer is coated onto said bio-based layer.

11. The composite of claim 10 wherein said adhesion layer comprises EVOH.

12. The composite of claim 10 wherein said adhesion layer comprises PVOH.

13. The composite of claim 10 wherein said adhesion layer comprises a PVOH/EAA mixture.

14. The composite of claim 10 wherein said adhesion layer comprises a primer layer.

15. The composite of claim 1 wherein said bio-based layer comprises PLA.

16. The composite of claim 1 wherein said bio-based layer comprises PHA.

17. A method for making a bio-based barrier film comprising the steps of:
a) applying an adhesion layer to a bio-based layer selected from PLA, PHA, and mixtures thereof;
b) applying a barrier layer to said adhesion layer.

18. The method of claim 17 wherein said adhesion layer is co-extruded with said bio-based layer.

19. The method of claim 18 wherein said adhesion layer comprises one or more polymers selected from amorphous PET, PGA, EVOH, nylon, and mixtures thereof.

20. The method of claim 17 wherein said adhesion layer is coated onto said bio-based layer.

21. The method of claim 20 wherein said adhesion layer comprises one or more polymers selected from EVOH, PVOH, a PVOH/EAA mixture, and a primer.
